(19) United States
(12) Patent Application Publication
(10) Pub. No.: US 2005/0097053 A1
(43) Pub. Date: May 5, 2005

(54) System and associated terminal, method and computer program product for protecting content

(75) Inventors: Janne La. Aaltonen, Turku (FI); Juha H. Salo, Littoinen (FI); Ahti Muhonen, Hirvihaara (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/701,087

(22) Filed: Nov. 4, 2003

(51) Int. Cl. G06F 17/60

(52) U.S. Cl. 705/51

(57) ABSTRACT

A system for protecting content includes a terminal capable of receiving content and storing the content in memory. The system also includes a first network entity capable of adding padding data to the received content, where the content and padding data form aggregate content having a size greater than a size of the content. Alternatively, the first network entity can modify a file allocation table entry of content stored by the terminal to thereby increase a perceived size of the content. A second network entity of the system is capable of accessing the aggregate content, and thereafter extracting the received content from the aggregate content upon request for the received content. Alternatively, the second network entity can extract the file allocation table entry of the received content from the modified file allocation table entry, and thereafter assemble the received content from the file allocation table entry of the received content.

### FIELD OF THE INVENTION

The present invention generally relates to systems and methods for protecting content and, more particularly, to systems and associated terminals, methods and computer program products for protecting content received from a content source.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. In this regard, the increased bit rates of 3G systems widen the possibilities for providing digital services.

The increased bit rates of 3G systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques have been investigated that could provide a practical solution for high data intensive tasks in terms of lower cost and convenience for the users involved.

One such delivery technique that has shown promise is Digital Video Broadcasting (DVB). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently transmitting large amounts of data over a broadcast channel to a high number of users at a lower cost, when compared to data transmission through mobile telecommunication networks using, e.g., 3G systems. Advantageously, DVB-T has also proven to be exceptionally robust in that it provides increased performance in geographic conditions that would normally affect other types of transmissions, such as the rapid changes of reception conditions, and hilly and mountainous terrain. On the other hand, DVB-H (handheld), which is also related to DVB-T, can provide such increased performance particularly for wireless data delivery to a handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and relatively very low cost digital broadband delivery techniques provides the possibility of interactive services such as unidirectional and bi-directional services such as audio and video streaming (e.g., TV, radio, etc.), file downloads and advanced gaming applications, etc.

As with the downloading and use of content in accordance with other conventional techniques, including cellular communication techniques, local transfer techniques and/or messaging techniques, there are some challenges with the protection of content delivered in accordance with digital broadband data broadcast techniques (e.g., DVB-T). Generally, conventional content protection can have several dimensions. In this regard, content can be protected by securing access to content. In such instances, the content may be available from content sources. Access to the content sources, however, can be controlled through, for example, firewalls, virtual private networks (VPNs) or the like. In addition to, or in lieu of, protecting access to content, content itself can be encrypted using any of a number of different encryption techniques, such as public key infrastructure (PKI) techniques. Further, content can be protected by using authentication schemes, as such are well known to those skilled in the art.

Whereas such techniques are adequate in protecting content delivered from a content source to a terminal, such techniques typically do not protect the same content being transferred from the terminal to another device, such as to another terminal. In this regard, such subsequent transfers of the content from the terminal can lead to losses to the content sources in the form of content piracy, particularly for pay content. To reduce the distribution of decrypted content from a terminal to other terminals, the Open Mobile Alliance (OMA) has developed a forward lock technique for digital rights management (DRM) protected content. The current forward lock technique, however, has proven to be rather easy to bypass. In this regard, it has been shown that applications such as dedicated file manager applications can be configured to transfer “forward locked” content. In addition, the forward locked content of current forward lock techniques may not be compatible with, or may not support, all software applications capable of otherwise utilizing such content.

### SUMMARY OF THE INVENTION

In light of the foregoing background, embodiments of the present invention provide an improved system and associated terminal, method and computer program product for protecting content. Embodiments of the present invention are capable of converting content received by the terminal to a form capable of being utilized by the terminal, but typically infeasible or undesirable to transfer from the terminal to any other network entity. As will be appreciated, the size of content is one of the factors that greatly affects the feasibility of transferring the content from one point to another. Thus, in one typical embodiment, the content is capable of being converted to increase the size, or perceived size, of the content to thereby discourage transfer of the content from the terminal.

According to one aspect of the present invention, a system is provided for protecting content. The system includes a terminal capable of receiving content and storing the content in memory. The system also includes a first network entity capable of operating a download manager, and a second network entity capable of operating a file manager. The first and second network entities can comprise any of a number of different network entities, and can comprise the same network entity, if so desired. Likewise, one or both of the network entities can comprise the terminal itself, if so desired.

Irrespective of the distribution of the terminal, and the first and second network entities, according to one embodiment of the present invention, the download manager of the first network entity is capable of adding padding data to the content received by the terminal, where the content and padding data form aggregate content having a size greater than the received content. The file manager of the second network entity is capable of accessing the aggregate content from memory of the terminal, and thereafter extracting the received content from the aggregate content upon request for the received content.

In another embodiment, the download manager is capable of modifying a file allocation table entry of content stored by the terminal to thereby increase a perceived size of the content. In this embodiment, the file manager is capable of extracting the file allocation table entry of the received content from the modified file allocation table entry, and thereafter assembling the received content from the file allocation table entry of the received content. In this regard, the file manager can extract the file allocation table entry and assemble the content upon request for the received content.

The terminal can be capable of operating at least one application capable of requesting the received content. In such instances, the file manager of the second network entity can be capable of receiving the request for the received content, and thereafter determining if the request comprises a request for use of the received content local to the terminal. Then, if the request comprises a request for use of the received content local to the terminal, the file manager can be capable of extracting the received content. More particularly, the download manager of the first network entity can also be capable of stamping the content with an identifier of the terminal. The file manager of the second network entity can then be capable of extracting the received content upon request for the received content from an application at the terminal, where the file manager is capable of determining if the request is from an application at the terminal based upon the identifier stamped on the content.

In instances in which the terminal is capable of operating application(s), the file manager of the second network entity can be capable of receiving the request for the received content as mentioned above. Thereafter, the file manager can determine if the request comprises a request for use of the received content to transfer to an authorized recipient. And if the request comprises a request for use of the received content to transfer to an authorized recipient, the file manager can be capable of extracting the received content from the aggregate content. After extracting the received content, the download manager of the first network entity can be capable of stamping the extracted content with an identifier of the recipient. Then, the application of the terminal requesting the received content can be capable of transferring the stamped, extracted content to the recipient.

According to other aspects of the present invention, a terminal, method and computer program product are provided for protecting content. Therefore, embodiments of the present invention provide a system and associated terminal, method and computer program product for protecting content, particularly content received by a terminal. Embodiments of the present invention are capable of altering the size, or perceived size, of content received by a terminal. By modifying the size, or perceived size of the content, the download manager of embodiments of the present invention is capable of making the content too large, or perceived too large, to transfer from the terminal to thereby protect the content received by the terminal. Thus, in contrast to conventional techniques for protecting content during transmission from a content source to the terminal, embodiments of the present invention are capable of protecting content after and/or during receipt by the terminal.

Also, the memory of the terminal is capable of storing aggregate content or content having a modified file allocation table entry. As such, and in contrast to the OMA DRM forward lock technique, a dedicated file manager application cannot be utilized to forward the original content. Further, because the file manager extracts or assembles the received content, all applications otherwise capable of utilizing the content can utilize the content from the content source. In contrast, as described above in the background section, techniques such as the forward lock technique, may not be compatible with, or may not support, all software applications capable of otherwise utilizing such content. Therefore, the system arid associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with embodiments of the present invention;

FIG. 3 is a functional block diagram of a digital broadcast receiving terminal, in accordance with one embodiment of the present invention;

FIG. 4 is a functional block diagram of the digital broadcaster, in accordance with one embodiment of the present invention;

FIG. 5 is a schematic block diagram of a mobile station that may operate as a terminal, according to embodiments of the present invention;

FIG. 6 is a functional block diagram of a terminal downloading content from a content source, in accordance with one embodiment of the present invention;

FIGS. 7A and 7B are flowcharts illustrating various steps in a method of protecting content, in accordance with one embodiment of the present invention; and

FIG. 8 illustrates download content with padding data added after the download content received from the content source, in accordance with embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

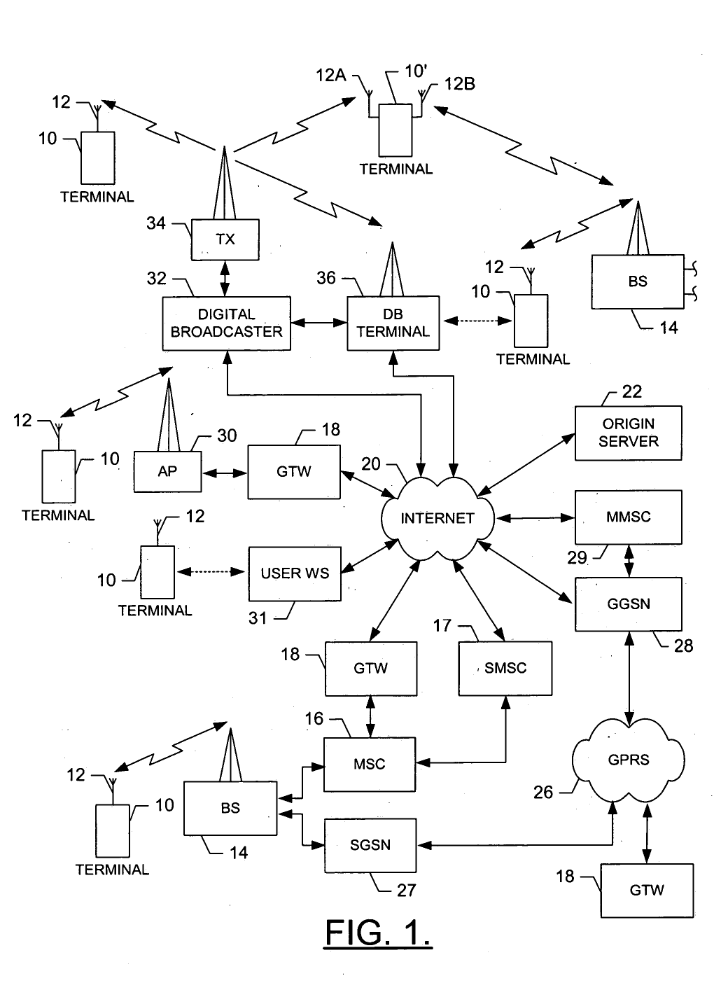

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also controlling the forwarding of messages for the terminal to and from a messaging center, such as short messaging service (SMS) messages to and from a SMS center (SMSC) 17.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with an origin server 22 or the like, one of which being illustrated in FIG. 1.

The BS 14 can also be coupled to a signaling GPRS (General Packet Radio Service) support node (SGSN) 24. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28, and the GGSN is coupled to the Internet. In addition to the GGSN, the packet-switched core network can also be coupled to a GTW 18. Also, the GGSN can be coupled to a messaging center, such as a multimedia messaging service (MMS) center 29. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 24 to the GPRS core network 26 and the GGSN 28, devices such as origin servers 22 can be coupled to the terminal 10 via the Internet 20, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

The terminal 10 can further be coupled to one or more wireless access points (APs) 30. The APs can comprise access points configured to communicate with the terminal in accordance techniques such as, for example, radio frequency (RF), Bluetooth (BT), infrared (IrDA) or any of a number of different wireless networking techniques, including WLAN techniques. Additionally, or alternatively, the terminal can be coupled to one or more user workstations (WS) 31. Each user workstation can comprise a computing system such as personal computers, laptop computers or the like. In this regard, the user workstations can be configured to communicate with the terminal in accordance with techniques such as, for example, RF, BT, IrDA or any of a number of different wireline or wireless communication techniques, including LAN and/or WLAN techniques. One or more of the user workstations can additionally, or alternatively, include a removable memory capable of storing content, which can thereafter be transferred to the terminal.

The APs 30 and the workstations 31 may be coupled to the Internet 20. Like with the MSC 16, the APs and workstations can be directly coupled to the Internet. In one advantageous embodiment, however, the APs are indirectly coupled to the Internet via a GTW 18. As will be appreciated, by directly or indirectly connecting the terminals and the origin server 22, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, the terminal 10 can additionally, or alternatively, be coupled to a digital broadcaster 32 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 34, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a cellular (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 32 via the TX 34, the terminal can be coupled to a digital broadcast (DB) receiving terminal 36 which, in turn, can be coupled to the digital broadcaster 32, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 20.

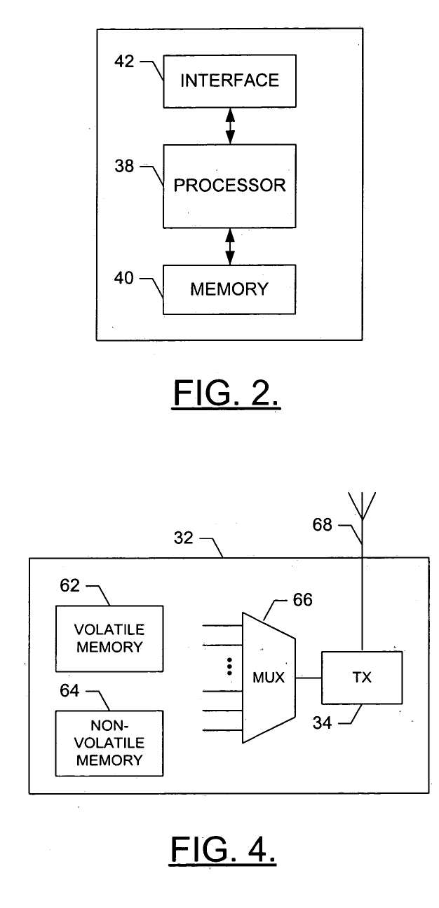

Referring now to FIG. 2, a block diagram of an entity capable of operating as a terminal 10, origin server 22, digital broadcast receiving terminal 36, and/or a digital broadcaster 32 is shown in accordance with one embodiment of the present invention. Although shown as separate entities, in some embodiments, one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

As shown, the entity capable of operating as a terminal 10, origin server 22, digital broadcast receiving terminal 36, and/or a digital broadcaster 32 can generally include a processor 38 connected to a memory 40. The processor can also be connected to at least one interface 42 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. Also, for example, the memory typically stores content transmitted from, or received by, the terminal, digital broadcast receiving terminal, and/or digital broadcaster.

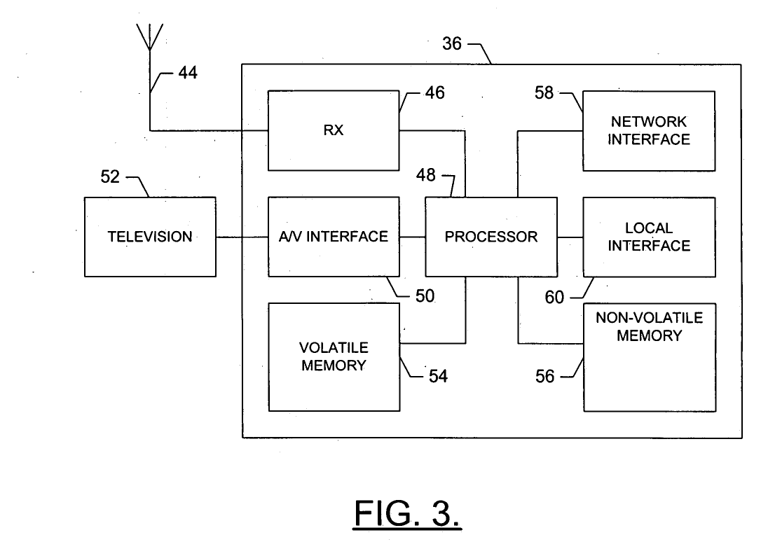

Reference is now made to FIG. 3, which illustrates a functional block diagram of a digital broadcast receiving terminal 36, in accordance with one embodiment of the present invention. As shown, the digital broadcast receiving terminal includes an antenna 44 for receiving signals from a digital broadcaster 32 and feeding the signals into a receiver (RX) 46. In turn, the receiver is capable of decrypting, demodulating and/or demultiplexing the signals, such as to extract content data. The receiver can feed the content data to a processor 48, which can thereafter decode the content data. The processor can then feed the decoded signal into an audio/video (A/V) interface 50, which can convert signals to a form suitable for display by a monitor, such as a television set 52.

The digital broadcast receiving terminal 36 can include volatile memory 54, such as volatile Random Access Memory (RAM) including a cache area for the temporary storage of data. The digital broadcast receiving terminal can also include non-volatile memory 56, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 32.

The digital broadcast receiving terminal 36 can also include one or more interface means for sharing and/or obtaining data from electronic devices, such as terminals 10 and/or digital broadcasters 32. More particularly, the digital broadcast receiving terminal can include a network interface means 58, for sharing and/or obtaining data from a network, such as the Internet 20. For example, the digital broadcast receiving terminal can include an Ethernet Personal Computer Memory Card International Association (PCMCIA) card configured to transmit and/or receive data to and from a network, such as the Internet.

The digital broadcast receiving terminal 36 can also include one or more local interface means 60 for locally sharing and/or obtaining data from electronic devices, such as a terminal. For example, the digital broadcast receiving terminal can include a radio frequency transceiver and/or an infrared (IR) transceiver so that data can be shared with and/or obtained in accordance with radio frequency and/or infrared transfer techniques. Additionally, or alternatively, for example, the digital broadcast receiving terminal can include a Bluetooth (BT) transceiver 52 operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

Reference is now made to FIG. 4, which illustrates a functional block diagram of the digital broadcaster 32 of one embodiment of the present invention. Like the digital broadcast receiving terminal 36, the digital broadcaster can include volatile memory 62, such as volatile Random Access Memory (RAM) including a cache area for the temporary storage of data. The digital broadcaster can also include non-volatile memory 64, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels.

The digital broadcaster 32 can also include a multiplexer 66, which can be capable of multiplexing content for a number of television, radio and/or data channels. The multiplexer can then feed the resulting signal into a TX 34, which can be separate from the digital broadcaster, as shown in FIG. 1, or incorporated within the digital broadcaster, as shown in FIG. 4. Irrespective of where the TX is located relative to the digital broadcaster, the TX can receive the signal from the multiplexer for encryption, modulation, amplification and/or transmission, such as via an antenna 68. In this regard, for example, the digital broadcaster can be capable of directly or indirectly transmitting content to a digital broadcast receiving terminal 36 and/or a terminal 10, such as in accordance with a digital broadcasting technique, such as DVB-T. For information on DVB-T, see European Telecommunications Standards Institute (ETSI) Standard EN 300 744, entitled: Digital Video Broadcasting (DVB): Framing structure, channel coding and modulation for digital terrestrial television, v.1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 10. In this regard, the digital broadcaster 32 can be capable of providing IP datacasting content to the terminal utilizing a digital broadcasting technique. As will be appreciated by those skilled in the art, digital broadcasting techniques such as DVB-T are essentially cellular in nature with a transmission site associated with each of a number of different cells. DVB-T, for example, uses MPEG-2 transport streams, and as such, IP data can be encapsulated into DVB transmission signals sent from the digital broadcaster, or more particularly the TX 34. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

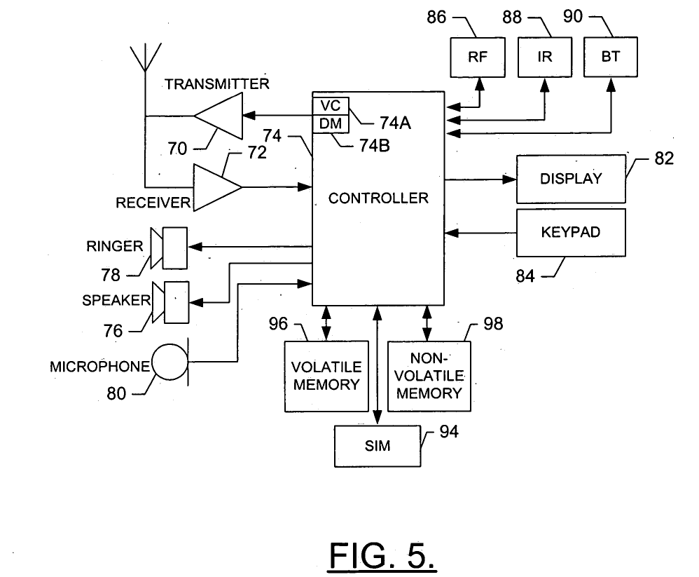

FIG. 5 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 70, a receiver 72, and a controller 74 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 74 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 74A, and may include an internal data modem (DM) 74B. Further, the controller may include the functionally to operate one or more software applications, which may be stored in memory.

The mobile station also comprises a user interface including a conventional earphone or speaker 76, a ringer 78, a microphone 80, a display 82, and a user input interface, all of which are coupled to the controller 74. The user input interface, which allows the mobile station to receive data, can comprise any of a number of devices allowing the mobile station to receive data, such as a keypad 84, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 22, an AP 30, a digital broadcast receiving terminal 36, a digital broadcaster 32 or the like, in accordance with any of a number of different wireline and/or wireless techniques. For example, the mobile station can include a radio frequency (RF) transceiver 86 and/or an infrared (IR) transceiver 88 such that the mobile station can share and/or obtain data in accordance with radio frequency and/or infrared techniques. Also, for example, the mobile station can include a Bluetooth (BT) transceiver 90 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

The mobile station can further include memory, such as a subscriber identity module (SIM) 94, a removable user identity module (R-UIM) or the like, which typically stores information elements related to a mobile subscriber. In addition to the SIM, the mobile station can include other memory. In this regard, like the digital broadcast receiving terminal 36 and the digital broadcaster 32, the mobile station can include volatile memory 96. Also, again like the digital broadcast receiving terminal and the digital broadcaster, the mobile station can include other non-volatile memory 98, which can be embedded and/or may be removable. For example, the other non-volatile memory can comprise embedded or removable multimedia memory cards (MMC's), Memory Sticks manufactured by Sony Corporation, EEPROM, flash memory, hard disk or the like.

The memories 94, 96, 98 can store any of a number of pieces of information, and data, used by the mobile station to implement the functions of the mobile station. For example, the memories can store an identifier, such as an international mobile equipment identification (IMEI) code, international mobile subscriber identification (IMSI) code, mobile station integrated services digital network (MSISDN) code or the like, capable of uniquely identifying the mobile station, such as to the MSC 16. The memories can also store content, such as that received from an origin server 22 and/or a digital broadcast receiving terminal. Also, for example, the memories can store one or more presentation applications such as a conventional text viewer, audio player, video player, multimedia viewer or the like. In addition, as described below, the memories can store a download manager and a file manager capable of protecting content received by the mobile station.

As indicated in the background section, conventional techniques for protecting content from a content source to a terminal include the use of firewalls, VPNs or the like, and can also include data encryption (e.g., PKI) techniques and/or authentication techniques. And whereas such conventional techniques for protecting content received from a content source are adequate, such techniques typically do not protect the same content being transferred from the terminal to another network entity, such as to another terminal. As also explained in the background section, techniques, such as the OMA DRM forward lock technique, have been developed to protect content transferred from the terminal. Techniques such as the forward lock technique, however, also have drawbacks. In this regard, the forward lock technique has proven to be rather easy to bypass with the use of dedicated file manager applications, and may not be compatible with, or may not support, all software applications capable of otherwise utilizing such content.

Embodiments of the present invention therefore provide an improved terminal 10 and method for protecting content. In this regard, embodiments of the present invention are capable of converting the content to a form capable of being utilized by the terminal 10, but typically infeasible or undesirable to transfer from the terminal to any other network entity, such as any other terminal, origin server 22 or the like. For example, embodiments of the present invention are capable of converting the content to a form such that the content is in a form infeasible or undesirable to transfer to another network entity in accordance with any of a number of different communication or transfer techniques, including any of a number of different cellular (e.g., 1G, 2G, 2.5G, 3G, etc.) communication techniques, such as GPRS, EDGE, MBMS, DVB (e.g., DVB-T, DVB-H, etc.), RF, BT, IrDA, and/or any of a number of different wireline and/or wireless networking techniques such as LAN and/or WLAN techniques, or via messaging services such as SMS, MMS, email or the like. As will be appreciated, the size of content is one of the factors that greatly affects the feasibility of transferring the content from one point to another. Thus, in one typical embodiment, the content is capable of being converted to increase the size, or perceived size, of the content to thereby discourage or prevent transfer of the content from the terminal.

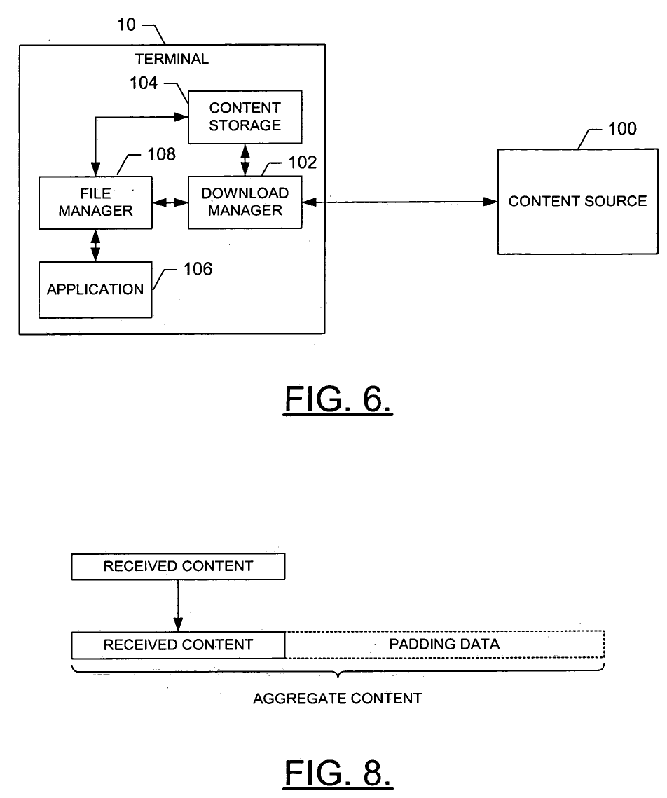

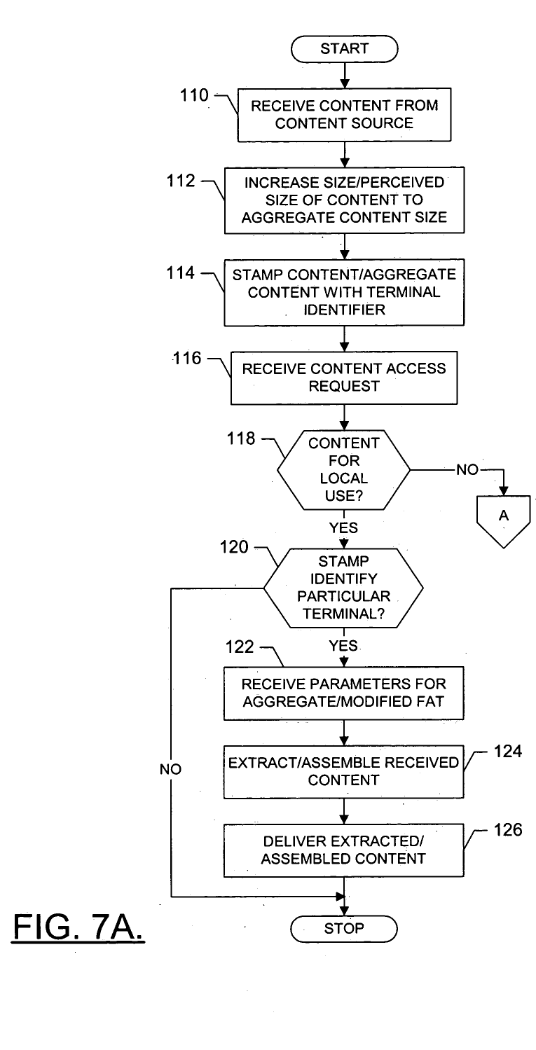

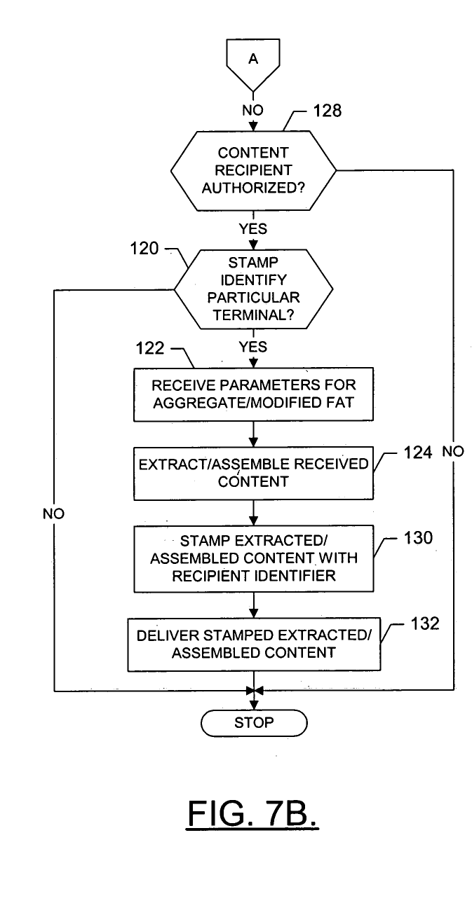

Reference is now drawn to FIGS. 6, 7A and 7B, which illustrate a functional block diagram and flowchart, respectively, of a terminal 10 and method of protecting content received by the terminal, in accordance with one embodiment of the present invention. More particularly, FIG. 6 illustrates a functional block diagram of a terminal downloading content from a content source 100, such as an origin server 22, a SMSC 17, a MMSC 29, a digital broadcaster 34, a digital broadcast receiving terminal 36 or the like, in accordance with one advantageous embodiment of the present invention. As shown in FIG. 6 and block 110 of FIG. 7A, the terminal is capable of operating a download manager 102, which is capable of receiving content from the content source 100, such as in accordance with any of a number of different transfer techniques. The download manager can then store the content in a content storage 104, where the content storage of one advantageous embodiment comprises non-volatile memory (e.g., non-volatile memory 98).

Before storing the content in the content storage 104, however, the download manager 102 is capable of converting the content to a form capable of being utilized by the terminal 10, but infeasible, impossible or otherwise undesirable to transfer from the terminal to any other network entity, such as any other terminal, an origin server 22, a SMSC 17, a MMSC 29 or the like. The download manager can convert the content in any of a number of different manners. In one typical embodiment, for example, the download manager can convert the content by adding padding data, such as a series of null bit values to the content, as shown in block 112. In this regard, the download manager can add the padding data to the content either as, or after, the download manager receives the content from the content source 100. The download manager can add the padding data after the content received from the content source, as shown in FIG. 8. Alternatively, the download manager can add padding data before or at one or more places within the content.

The download manager 102 preferably adds the padding data in a manner such that the combination of the content and the padding data forms aggregate content having a size sufficiently small to be stored by the content storage 104, but sufficiently large to discourage transfer from the terminal 10. For example, the download manager can add padding data to the content such that the aggregate content has a size two or more times the size of the original content. Advantageously, for example, the aggregate content can be large enough such, that an undesirable amount of time is required to transfer from the terminal, typically a size exceeding an acceptable size for communication applications of the terminal capable of otherwise transferring the content from the terminal. For example, if the terminal is capable of sending e-mail messages, SMS messages or the like having an acceptable size less than or equal to a predetermined size, the download manager can be capable of adding the padding data to the content such that the aggregate content has a size exceeding the predetermined size.

In lieu of increasing the size of the content by adding the padding content, the download manager 102 can be capable of modifying the content, or characteristics of the content, in a manner that can be interpreted as specifying an increased size of the content such that the content is perceived to have an increased size, even though no additional padding data has been added to the content. For example, as also shown in block 112, the download manager can be capable of modifying a file allocation table (FAT) entry for the content such that the perceived size of the content is larger, typically substantially larger, than the actual size of the content. As is well known to those skilled in the art, the FAT comprises a table, maintained by a software operating system, that provides a map of the clusters of logical storage in content storage 104 including portions of stored content. Thus, when content is accessed from content storage, such as by another application, the operating system assembles the content from clusters and provides the assembled content to the file manager. By modifying the FAT entry of the content, then, the download manager can “trick” applications that access the content to believe that the content has an increased size, as opposed the smaller size of the content itself.

In addition to increasing the size, or perceived size, of the content, the download manager 102 can also be capable of electronically stamping the content with an identifier capable of uniquely identifying the particular terminal 10 storing the content, as shown in block 114. For example, the download manager can be capable of electronically stamping the content with the IMEI code, IMSI code, MSISDN code or the like of a mobile station storing the content. By stamping the content with the identifier of the terminal, the download manager can be further capable of controlling subsequent usage of the content by the terminal, as well as other network entities that may subsequently receive the content from the terminal. More particularly, as described below, the download manager can further control subsequent usage of the content by the terminal by stamping the content with the identifier such that the identifier of the terminal storing the content must match the stamped identifier to access the content.

In addition to the download manager 102, the terminal 10 is capable of operating an application 106, such as a conventional Web browser, text viewer, audio player, video player, multimedia viewer or the like, which is capable of receiving and locally utilizing the content from the content storage 104. Because of the padding data and/or the modified FAT entry, however, the application is typically incapable of accurately receiving the content from the content storage. In this regard, the terminal is further capable of operating a file manager 108, which is capable of delivering content from content storage to the application. Thus, when an application desires to access the content, the application requests the content from the file manager, as shown in block 116.

Upon receipt of a content request from an application 106, the file manager 108 can determine if the application requests the content for local use, such as for local presentation on a user interface (e.g., display 82) of the terminal 10 in accordance with any of a number of known techniques, as shown in block 118. If the application requested the content for local use, the file manager can determine if the electronic stamp on the content (if applied) identifies the particular terminal 10 storing the content, as shown in block 120. If the electronic stamp does not identify the particular terminal storing the content, the file manager can refuse to deliver the extracted or assembled content to the application 106 and end the process. If the electronic stamp does identify the particular terminal, however, the file manager can access the content storage 104 and communicate with the download manager to interpret the aggregate content or modified FAT entry.

The file manager 108 can communicate with the download manager 102 to receive, from the download manager, information including one or more parameters of the aggregate content or the modified FAT entry, as shown in block 122. For example, the file manager can communicate with the download manager to receive information that, directly or indirectly, indicates the size, as well as position(s) of the padding data in the aggregate content. Alternatively, for example, the file manager can communicate with the download manager to receive information that, directly or indirectly, indicates the actual clusters of memory storing the content. Once the file manager 108 has received the parameter(s) of the aggregate content or the modified FAT entry, the file manager can extract the original content from the aggregate content, as shown in block 124. Alternatively, the file manager can extract the FAT entry of the original content from the modified FAT entry, and thereafter assemble the original content from the FAT entry of the content (as opposed to the modified FAT entry). Thereafter, the file manager can deliver the extracted or assembled content to the application 106, as shown in block 126. Upon receipt of the content, then, the application can present the content, such as via a user interface (e.g., display 82) of the terminal.

Typically, an application 106 receiving content from the file manager 108 is not capable of transferring the content from the terminal 10 to another network entity. However, in various instances, the file manager may receive a content request from an application capable of communicating with another network entity (e.g., another terminal, an origin server 22, etc.), where the application requests the content to transfer to another network entity. In such instances, as shown in block 128 of FIG. 7B, the file manager can, but need not, be capable of providing the extracted or assembled content to the application, typically provided that the recipient of the content, i.e., the other network entity, has been authorized to receive such content. In this regard, the file manager can determine whether the recipient of the content is authorized in any known manner. For example, the file manager can request and thereafter receive, from the content source 100, an indication as to whether a recipient is authorized to receive such content. Thereafter, the file manager can operate, as before, to determine if the electronic stamp on the content (if applied) identifies the particular terminal 10 storing the content, receive the parameters from the download manager 102, and extract and assemble the content, as shown in blocks 120, 122 and 124.

In addition, in instances in which the file manager 108 provides the content to an application to transfer to another network entity, the file manager can receive an identifier (e.g., the IMEI code, IMSI code, MSISDN code, etc.) of the recipient, i.e., network entity, desiring to receive the content. In this regard, the file manager can communicate with the download manager 102 such that the download manager can electronically stamp the content with the identifier of the receiving network entity, as shown in block 130 of FIG. 7B. By stamping the content with the identifier of the receiving network entity before providing the content to the application transferring the content to the receiving network entity, the file manager and download manager can be further capable of controlling subsequent usage of the content by the receiving network entity, such as in the same manner as stamping the content controls subsequent usage of the content by the terminal 10. Thus, after stamping the content the file manager can deliver the stamped content to the application, as shown in block 132, which can thereafter transfer the stamped content to the receiving network entity.

As described herein, the download manager 102, applications 106 and file manager 108 typically comprise software capable of being stored within memory (e.g., non-volatile memory 98), and operated by a processor, controller (e.g., controller 74) or the like of a terminal 10. It should be understood, however, that the download manager, applications and/or file manager can alternatively comprise firmware or hardware, without departing from the spirit and scope of the present invention. It should also be understood that, although shown as separate entities, in some embodiments, one or more entities may support one or more of a download manager, applications and file manager, logically separated but co-located within the entit(ies). For example, a single entity may support a logically separate, but co-located, applications and file manager.

Further, it should be understood that, although typically operated by a terminal, any of a number of network entities (e.g., origin server 22, SMSC 17, MMSC 29, digital broadcaster 32 and/or digital broadcast receiving terminal 36) can be capable of operating any one or more of the download manager, applications and file manager. For example, a first network entity can comprise an origin server capable of operating the download manager, while a second network entity, comprising a terminal, operates the file manager. Alternatively, for example, a first network entity can comprise an origin server capable of operating the download manager, while a second network entity, comprising the same or a different origin server, operates the file manager.

As explained above, the download manager 102 is capable of altering the size, or perceived size, of content received from a content source 100. By so modifying the content, the download manager is capable of protecting content received by the terminal 10. Thus, in contrast to conventional techniques for protecting content from a content source to the terminal, embodiments of the present invention are capable of protecting content after receipt by the terminal. As also explained above, the content storage stores aggregate content or content having a modified FAT entry such that subsequent applications, except for the file manager 108, receive the aggregate content or content with a perceived increased size. Thus, in contrast to the OMA DMA forward lock technique, a dedicated file manager application cannot be utilized to forward the original content.

Further, as explained above, the file manager 108 is capable of extracting or assembling content from the aggregate content or modified FAT entry. Thereafter, the file manager can provide the extracted or assembled content, which comprises the original content received from the content source, to an application 106. As the application receives the original content, as opposed to modified content, all applications otherwise capable of utilizing the content can utilize the content from the content source. In contrast, as described above in the background section, techniques such as the forward lock technique, may not be compatible with, or may not support, all software applications capable of otherwise utilizing such content.

According to one aspect of the present invention, all or a portion of the system of the present invention, such all or portions of the terminal 10, generally operates under control of a computer program product (e.g., download manager 102, applications 106 and/or file manager 108). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 6, 7A and 7B are a functional block diagram and flowcharts of methods, systems and program products according to the invention. It will be understood that each block or step of the block diagram and flowcharts, and combinations of blocks in the block diagram and flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the block diagram and flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the block diagram and flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the block diagram and flowcharts.

Accordingly, blocks or steps of the block diagram and flowcharts support combinations of means for performing the specified functions, combinations of steps for performing the specified functions and program instruction means for performing the specified functions. It will also be understood that each block or step of the block diagram and flowcharts, and combinations of blocks or steps in the block diagram and flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for protecting content comprising:
a terminal capable of receiving content and storing the content in memory;
a first network entity capable of operating a download manager, wherein the download manager is capable of adding padding data to the content received by the terminal, wherein the content and padding data form aggregate content having a size greater than a size of the received content; and
a second network entity capable of operating a file manager, wherein the file manager is capable of accessing the aggregate content from memory of the terminal, and thereafter extracting the received content from the aggregate content upon request for the received content.

2. A system according to claim 1, wherein the terminal is also capable of operating at least one application capable of requesting the received content, wherein the file manager of the second network entity is capable of receiving the request for the received content, and thereafter determining if the request comprises a request for use of the received content local to the terminal, and wherein the file manager is capable of extracting the received content if the request comprises a request for use of the received content local to the terminal.

3. A system according to claim 1, wherein the download manager of the first network entity is also capable of stamping the content with an identifier of the terminal, wherein the file manager of the second network entity is capable of extracting the received content upon request for the received content from an application at the terminal, and wherein the file manager is capable of determining if the request is from an application at the terminal based upon the identifier stamped on the content.

4. A system according to claim 1, wherein the terminal is also capable of operating at least one application capable of requesting the received content, wherein the file manager of the second network entity is capable of receiving the request for the received content, and thereafter determining if the request comprises a request for use of the received content to transfer to an authorized recipient, and wherein the file manager is capable of extracting the received content from the aggregate content if the request comprises a request for use of the received content to transfer to an authorized recipient.

5. A system according to claim 4, wherein the download manager of the first network entity is also capable of stamping the extracted content with an identifier of the recipient, and wherein the application of the terminal requesting the received content is capable of transferring the stamped, extracted content to the recipient.

6. A system according to claim 1, wherein the terminal comprises the first network entity and the second network entity.

7. A system of protecting content comprising:
a terminal capable of receiving content and storing the content in memory;
a first network entity capable of operating a download manager, wherein the download manager is capable of modifying a file allocation table entry of content stored by the terminal to thereby increase a perceived size of the content; and
a second network entity capable of operating a file manager, wherein the file manager is capable of extracting the file allocation table entry of the received content from the modified file allocation table entry, and thereafter assembling the received content from the file allocation table entry of the received content, and wherein the file manager is capable of extracting the file allocation table entry and assembling the content upon request for the received content.

8. A system according to claim 7, wherein the terminal is also capable of operating at least one application capable of requesting the received content, wherein the file manager of the second network entity is capable of receiving the request for the received content, and thereafter determining if the request comprises a request for use of the received content local to the terminal, and wherein the file manager is capable of extracting the file allocation table entry and assembling the received content if the request comprises a request for use of the received content local to the terminal.

9. A system according to claim 7, wherein the download manager of the first network entity is also capable of stamping the content with an identifier of the terminal, wherein the file manager of the second network entity is capable of extracting the file allocation table entry and assembling the content upon request for the received content from an application at the terminal, and wherein the file manager is capable of determining if the request is from an application at the terminal based upon the identifier stamped on the content.

10. A system according to claim 7, wherein the terminal is also capable of operating at least one application capable of requesting the received content, wherein the file manager of the second network entity is capable of receiving the request for the received content, and thereafter determining if the request comprises a request for use of the received content to transfer to an authorized recipient, and wherein the file manager is capable of extracting the file allocation table entry and assembling the content if the request comprises a request for use of the received content to transfer to an authorized recipient.

11. A system according to claim 10, wherein the download manager of the first network entity is also capable of stamping the extracted content with an identifier of the recipient, and wherein the application of the terminal requesting the received content is capable of transferring the stamped, extracted content to the recipient.

12. A system according to claim 7, wherein the terminal comprises the first network entity and the second network entity.

13. A terminal for protecting content comprising:
a controller capable of operating a download manager and a file manager, wherein the download manager is capable of adding padding data to content received at a terminal, wherein the content and padding data form aggregate content having a size greater than a size of the received content; and
a memory capable of storing the aggregate content,
wherein the file manager is capable of accessing the aggregate content from memory of the terminal, and thereafter extracting the received content from the aggregate content upon request for the received content.

14. A terminal according to claim 13, wherein the controller is also capable of operating at least one application capable of requesting the received content, wherein the file manager is capable of receiving the request for the received content, and thereafter determining if the request comprises a request for use of the received content local to the terminal, and wherein the file manager is capable of extracting the received content if the request comprises a request for use of the received content local to the terminal.

15. A terminal according to claim 13, wherein the download manager is also capable of stamping the content with an identifier of the terminal, wherein the file manager is capable of extracting the received content upon request for the received content from an application at the terminal, and wherein the file manager is capable of determining if the request is from an application at the terminal based upon the identifier stamped on the content.

16. A terminal according to claim 13, wherein the controller is also capable of operating at least one application capable of requesting the received content, wherein the file manager is capable of receiving the request for the received content, and thereafter determining if the request comprises a request for use of the received content to transfer to an authorized recipient, and wherein the file manager is capable of extracting the received content from the aggregate content if the request comprises a request for use of the received content to transfer to an authorized recipient.

17. A terminal according to claim 16, wherein the download manager is also capable of stamping the extracted content with an identifier of the recipient, and
wherein the application requesting the received content is capable of transferring the stamped, extracted content to the recipient.

18. A terminal of protecting content comprising:
a controller capable of operating a download manager and a file manager, wherein the download manager is capable of modifying a file allocation table entry of content received at a terminal to thereby increase a perceived size of the content; and
a memory capable of storing the content and file allocation table entry,
wherein the file manager is capable of extracting the file allocation table entry of the received content from the modified file allocation table entry, and thereafter assembling the received content from the file allocation table entry of the received content, and wherein the file manager is capable of extracting the file allocation table entry and assembling the content upon request for the received content.

19. A terminal according to claim 18, wherein the controller is also capable of operating at least one application capable of requesting the received content, wherein the file manager is capable of receiving the request for the received content, and thereafter determining if the request comprises a request for use of the received content local to the terminal, and wherein the file manager is capable of extracting the file allocation table entry and assembling the received content if the request comprises a request for use of the received content local to the terminal.

20. A terminal according to claim 18, wherein the download manager is also capable of stamping the content with an identifier of the terminal, wherein the file manager is capable of extracting the file allocation table entry and assembling the content upon request for the received content from an application at the terminal, and wherein the file manager is capable of determining if the request is from an application at the terminal based upon the identifier stamped on the content.

21. A terminal according to claim 18, wherein the controller is also capable of operating at least one application capable of requesting the received content, wherein the file manager is capable of receiving the request for the received content, and thereafter determining if the request comprises a request for use of the received content to transfer to an authorized recipient, and wherein the file manager is capable of extracting the file allocation table entry and assembling the content if the request comprises a request for use of the received content to transfer to an authorized recipient.

22. A terminal according to claim 21, wherein the download manager is also capable of stamping the extracted content with an identifier of the recipient, and
wherein the application requesting the received content is capable of transferring the stamped, extracted content to the recipient.

23. A method of protecting content comprising:
adding padding data to content received at a terminal, wherein the content and padding data form aggregate content having a size greater than a size of the received content;
storing the aggregate content in memory of the terminal;
accessing the aggregate content from memory of the terminal; and
extracting the received content from the aggregate content upon request for the received content.

24. A method according to claim 23 further comprising:
receiving a request for the received content; and
determining if the request comprises a request for use of the received content local to the terminal,
wherein extracting the received content comprises extracting the received content if the request comprises a request for use of the received content local to the terminal.

25. A method according to claim 23 further comprising:
stamping the content with an identifier of the terminal including memory storing the content,
wherein extracting the received content comprises extracting the received content upon request for the received content at the terminal including memory storing the content, and wherein the request for the received content at the terminal including memory storing the content can be determined based upon the identifier stamped on the content.

26. A method according to claim 23 further comprising:
receiving a request for the received content; and
determining if the request comprises a request for use of the received content to transfer to an authorized recipient,
wherein extracting the received content comprises extracting the received content from the aggregate content if the request comprises a request for use of the received content to transfer to an authorized recipient.

27. A method according to claim 26 further comprising:
stamping the extracted content with an identifier of the recipient; and
transferring the stamped, extracted content to the recipient.

28. A method of protecting content comprising:
modifying a file allocation table entry of content received at a terminal to thereby increase a perceived size of the content;
storing the content and file allocation table entry in memory of the terminal;
extracting the file allocation table entry of the received content from the modified file allocation table entry; and
assembling the received content from the file allocation table entry of the received content, wherein extracting the file allocation table entry and assembling the content occur upon request for the received content.

29. A method according to claim 28 further comprising:
receiving a request for the received content; and
determining if the request comprises a request for use of the received content local to the terminal,
wherein extracting the file allocation table entry and assembling the received content comprise extracting the file allocation table entry and assembling the received content if the request comprises a request for use of the received content local to the terminal.

30. A method according to claim 28 further comprising:
stamping the content with an identifier of the terminal including memory storing the content,
wherein extracting the file allocation table entry and assembling the content comprise wherein extracting the file allocation table entry and assembling the content upon request for the received content at the terminal including memory storing the content, and wherein request for the received content at the terminal including memory storing the content can be determined based upon the identifier stamped on the content.

31. A method according to claim 28 further comprising:
receiving a request for the received content; and
determining if the request comprises a request for use of the received content to transfer to an authorized recipient,
wherein extracting the file allocation table entry and assembling the content comprise extracting the file allocation table entry and assembling the content if the request comprises a request for use of the received content to transfer to an authorized recipient.

32. A method according to claim 31 further comprising:
stamping the assembled content with an identifier of the recipient; and
transferring the stamped, assembled content to the recipient.

33. A computer program product for protecting content, the computer program product comprising a computer-readable storage medium having computer-readable program code portions stored therein, the computer-readable program code portions comprising:
a first executable portion for adding padding data to content received at a terminal, wherein the content and padding data form aggregate content having a size greater than a size of the received content;
a second executable portion for storing the aggregate content in memory of the terminal;
a third executable portion for accessing the aggregate content from memory of the terminal; and
a fourth executable portion for extracting the received content from the aggregate content upon request for the received content.

34. A computer program product according to claim 33 further comprising:
a fifth executable portion for receiving a request for the received content; and
a sixth executable portion for determining if the request comprises a request for use of the received content local to the terminal,
wherein the fourth executable portion is adapted to extract the received content if the request comprises a request for use of the received content local to the terminal.

35. A computer program product according to claim 33 further comprising:
a fifth executable portion for stamping the content with an identifier of the terminal including memory storing the content,
wherein the fourth executable portion is adapted to extract the received content upon request for the received content at the terminal including memory storing the content, and wherein request for the received content at the terminal including memory storing the content can be determined based upon the identifier stamped on the content.

36. A computer program product according to claim 33 further comprising:
a fifth executable portion for receiving a request for the received content; and
a sixth executable portion for determining if the request comprises a request for use of the received content to transfer to an authorized recipient,
wherein the fourth executable portion is adapted to extract the received content from the aggregate content if the request comprises a request for use of the received content to transfer to an authorized recipient.

37. A computer program product according to claim 36 further comprising:
a seventh executable portion for stamping the extracted content with an identifier of the recipient; and
an eighth executable portion for transferring the stamped, extracted content to the recipient.

38. A computer program product of protecting content comprising:
a first executable portion for modifying a file allocation table entry of content received at a terminal to thereby increase a perceived size of the content;
a second executable portion for storing the content and file allocation table entry in memory of the terminal;
a third executable portion for extracting the file allocation table entry of the received content from the modified file allocation table entry; and
a fourth executable portion for assembling the received content from the file allocation table entry of the received content, wherein extracting the file allocation table entry and assembling the content occur upon request for the received content.

39. A computer program product according to claim 38 further comprising:
a fifth executable portion for receiving a request for the received content; and
a sixth executable portion for determining if the request comprises a request for use of the received content local to the terminal,
wherein the third and fourth executable portions are adapted to extract the file allocation table entry and assemble the received content, respectively, if the request comprises a request for use of the received content local to the terminal.

40. A computer program product according to claim 38 further comprising:
a fifth executable portion for stamping the content with an identifier of the terminal including memory storing the content,
wherein the third and fourth executable portions are adapted to extract the file allocation table entry and assemble the received content, respectively, upon request for the received content at the terminal including memory storing the content, and wherein request for the received content at the terminal including memory storing the content can be determined based upon the identifier stamped on the content.

41. A computer program product according to claim 38 further comprising:
a fifth executable portion for receiving a request for the received content; and
a sixth executable portion for determining if the request comprises a request for use of the received content to transfer to an authorized recipient,
wherein the third and fourth executable portions are adapted to extract the file allocation table entry and assemble the received content, respectively, if the request comprises a request for use of the received content to transfer to an authorized recipient.

42. A computer program product according to claim 41 further comprising:
a seventh executable portion for stamping the assembled content with an identifier of the recipient; and
an eighth executable portion for transferring the stamped, assembled content to the recipient.
